(19) United States
(12) Patent Application Publication
(10) Pub. No.: US 2026/0145780 A1
(43) Pub. Date: May 28, 2026

(54) Counter-Balanced Control Stick

(71) Applicant: Safran Electronics & Defense, Avionics USA, LLC, Grand Prairie, TX (US)

(72) Inventors: Andrew Wright, MOISSY-CRAMAYEL (FR); Ryan Fleming, MOISSY-CRAMAYEL (FR)

(73) Assignee: Safran Electronics & Defense, Avionics USA, LLC, Grand Prairie, TX (US)

(21) Appl. No.: 19/121,754

(22) PCT Filed: Nov. 10, 2022
(86) PCT No.: PCT/US2022/049592

§ 371 Date: Apr. 16, 2025

(51) Int. Cl. B64C 13/14; B64C 13/04; B64D 45/00

(52) U.S. Cl. CPC B64C 13/14; B64C 13/042; B64D 45/00

(57) ABSTRACT

Inceptor systems and control levers for aircraft are described that are substantially mass balanced to eliminate false sensor readings on the control levers due to the presence of external forces such as acceleration acting on the control levers. The lever can be mass balanced using existing components such as the motor and its structure to avoid the need for additional mass. By constricting movement of the motor, this can also avoid the need for additional volume that would otherwise be required for the counterbalancing elements to sweep with movement of the lever. A linkage can be used to restrict movement of the motor while reading forces that acts upon the lever.

### FIELD OF THE INVENTION

The field of the invention is control inceptors.

### BACKGROUND

The following description includes information that may be useful in understanding the present invention. It is not an admission that any of the information provided herein is prior art or relevant to the presently claimed invention, or that any publication specifically or implicitly referenced is prior art.

A conventional architecture of a backdriven control lever 100 for an aircraft is shown in FIG. 1. The control lever 100 has an upper portion 102 with a lever grip 104 at a first end. A gear 106 is fixed to the lever 100 at a second end, such that rotation of the lever 100 causes rotation of the gear 106. The lever 100 and gear 106 are configured to rotate or pivot about a first axis at a pivot point 108. The lever is mechanically coupled to a stationary motor 110 via the gear 106 that interacts with a motor pinion 112.

While offering a compact configuration, the control lever 100 has a tendency for acceleration disturbance leading to unintended motion (creep) due to vibration, shock, and/or constant acceleration. In addition, gravity effects can alter the intended feel of the control lever 100 and additionally pollute lever force sensing that may be instrumented on the inceptor.

Various solutions exist to limit or prevent unintended motion of the control lever of an aircraft. One solution is shown in FIG. 2. Again, the control lever 200 has an upper portion 202 with a lever grip 204 at a first end. A gear 206 is fixed to the lever 200 at a second end, such that rotation of the lever 200 causes rotation of the gear 206. The lever 200 and gear 206 are configured to rotate or pivot about a first axis at a pivot point 208. The lever is mechanically coupled to a stationary motor 210 via the gear 206 that interacts with a motor pinion 212.

To help limit unintended motion of the lever 200, springs 220 can be coupled to the upper portion 202 of the lever 200 in order to add compensation to bias the lever 200 to a neutral position. The springs 220 act to limit unintended movement of the lever 200 and thereby limit an effect of acceleration disturbances on the control lever 200. This solution is not ideal as the springs 220 have a fixed spring constant and therefore the spring compensation is static and not necessarily matched to the disturbance which varies with the aircraft's attitude and shock/vibration direction as well as magnitude of the force.

In addition, the springs 220 only counteract disturbances in one position of the lever 200 (e.g., vertical) with respect to constant acceleration orientation and magnitude (e.g., gravity).

Another solution is to increase the friction to thereby prevent unintended movement of the control lever. Again, this solution is not ideal as the friction applied is static and not necessarily matched to the disturbance which varies with the aircraft's attitude and shock/vibration direction as well as magnitude of the force. While variable friction (e.g., active compensation) could be used, such solutions would be more complex increasing the overall weight, cost, and failure rate of the system.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for instrumenting control levers for force sensing which limits unintended motion of the lever without increasing a volume or mass of the lever and without injecting unintended acceleration disturbances as active or passive lever force.

### SUMMARY OF THE INVENTION

The inventive subject matter provides apparatus, systems, and methods for instrumentation of control levers for aircraft that limits unintended motion of the lever under active force control. Such unintended motion typically results from external accelerations of the aircraft causing unwanted motion of the lever. The inventive subject matter assists in reducing or eliminating sensors on the lever from reading in the effects of vibration, shock, acceleration, gravity.

In some embodiments, contemplated levers, which may be part of an inceptor system, have a lever grip at a first end and are configured to rotate about a pivot point (i.e., first axis). A motor can be coupled to the lever such that the motor acts as a counterbalance to the lever, so that the lever grip mass (M_{grip}) is balanced. The motor and control lever are mechanically linked such that rotation of the lever is transmitted to the motor. As a result of the additional weight, the center of gravity of the lever is approximately at the pivot point.

In other embodiments, a control lever for an aircraft comprises an upper portion and a lower portion. The upper portion has a control stick that is configured to rotate about a first axis. The lower portion comprises a motor mechanically linked to the control lever such that rotation of the lever about the first axis is transmitted to the motor. The lower portion preferably comprises a linkage that couples the motor to the lever, wherein the linkage constrains movement of the motor. In these embodiments, it is preferred that a mass of the upper portion is approximately equal to a mass of the lower portion.

In such embodiments, the control lever is substantially mass balanced about its axis to provide an increased resistance to movement under acceleration. By incorporating the mass of the motor into the balance of the control lever, the lever can provide increased neutrality to acceleration without using additional counterweights or electrical/mechanical components, thereby providing the advantages described herein without the additional weight or complexity of prior art solutions.

The context of the inventive subject matter discussed herein is in the active feel function for pilot controls. Active feel provides feedback on the lever to assist pilots when flying the aircraft, as newer aircraft utilize a fly-by-wire electronic control system where pilot inputs are converted to electric signals to causes changes in aircraft speed, direction, and so forth, rather than traditional mechanical linkages. Active feel is dependent on force sensor signals which may be polluted by unwanted inputs. The inventive subject matter discussed herein minimizes the undesired signals (such as external acceleration forces) from the desired force to provide better active feedback of the lever feel and positioning. This is achieved by specific arrangement of existing components without increasing the overall mass or sweeping volume of the lever or its system.

In some embodiments, an active force feedback aircraft pilot inceptor system comprises a housing structure, a moving lever input assembly, a counter-balancing actuation subsystem, a transmission which connects the lever input assembly to the counter-balancing actuation system, a force sensing sub-system which fixes the counter-balancing actuation system to the housing structure, and an integrated electronic controller which controls the lever force and motion based on observed sensors including the force sensing sub-system.

The inventive subject matter is distinct from other known solutions because it improves the force signal quality without adding additional sensors, mass, or volume. In addition, the inventive subject matter may be combined with existing components for added benefit.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” means within 10.0 millimeters, 5.0 millimeters, 1.0 millimeter, 0.9 millimeters, 0.8 millimeters, 0.7 millimeters, 0.6 millimeters, 0.5 millimeters, 0.4 millimeters, 0.3 millimeters, 0.2 millimeters or 0.1 millimeters, 0.05 millimeters, or 0.01 millimeters of a given value or range.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a traditional control lever for an aircraft.

FIG. 2 is a schematic of another embodiment of a control lever with spring compensation of lever acceleration disturbances.

FIG. 3 is a schematic of another embodiment of a control lever with mass counterbalance compensation of lever acceleration disturbances.

FIGS. 4A-4B are schematics of another embodiment of a control lever of a moving motor acting as the mass counterbalance.

FIGS. 5A-5B are schematics of an embodiment of an inceptor system using multiple sensor feedback to filter lever acceleration disturbances in the lever force instrumentation.

FIG. 6 is a schematic of another embodiment of an inceptor system which uses the stationary motor mass to largely counterbalance the lever body from the force sensor.

FIG. 7 is a schematic of another embodiment of an inceptor system of FIG. 6 which includes additional sensor feedback to enhance disturbance rejection.

FIG. 8 is a schematic of another embodiment of an inceptor system of FIG. 6 which uses rotary torque sensing rather than linear force sensing.

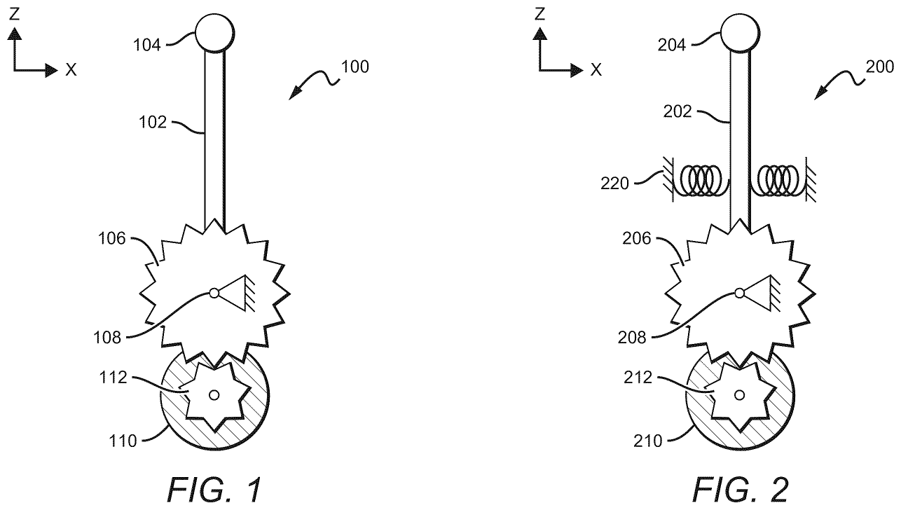

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

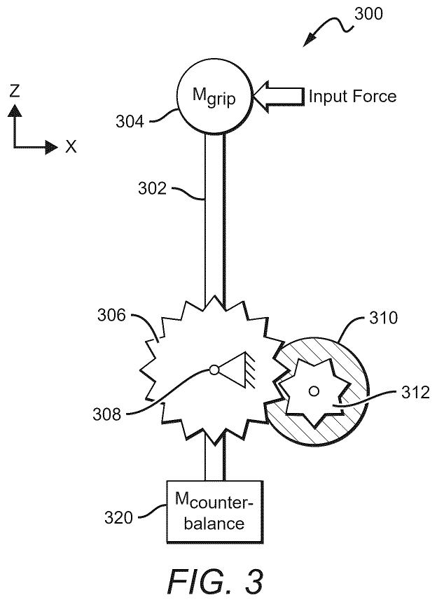

FIG. 3 illustrates a schematic of another embodiment of a control lever 300. The control lever 300 has an upper portion 302 with a lever grip 304 at a first end. A gear 306 is fixed to the control lever 300, such that rotation of the lever 300 causes rotation of the gear 306. The lever 300 and gear 306 are configured to rotate or pivot about a first axis at a pivot point 308 having a first axis. In this manner, the lever 300 rotates about the first axis.

The lever 300 is preferably mechanically coupled to a stationary motor 310 via the gear 306 that interacts with a motor pinion 312. In this embodiment, the motor 310 does not move as the lever 300 rotates about the pivot point 308.

A weight 320 can be added to an opposing end of the lever 300, which acts as a counterweight to the mass of the upper portion 302. By balancing the masses below and above the pivot point 308, the center of gravity of the lever 300 is at or approximately at the pivot point 308 (i.e., at the center of rotation of the lever 300). Under such circumstances, the inertial disturbance torque cancels when the combined center of gravity is at the pivot point 308.

By adding weight 320, the control lever 300 can be immune to force disturbances due to external accelerations. However, the weight 320 adds extra volume and weight to the lever 300 and requires room to sweep as the weight 320 moves with rotation of the control lever 300. This relationship is shown in the following formula:

$${T}_{l e v e r} = ( {T}_{grip} + {T}_{weight} ) + {T}_{input}$$

Thus, when the torque due to the mass of the lever upper portion 302 (simplified in the formula as T_{grip}), and torque due to the mass of the counterweight 320 (T_{weight}), are equal but opposite values, the values cancel one another, and the torque of the lever 300 equals the input torque (input force Tᵢₙₚᵤₜ). In this manner, force sensors can accurately determine the input force applied to the grip 304 of the lever 300.

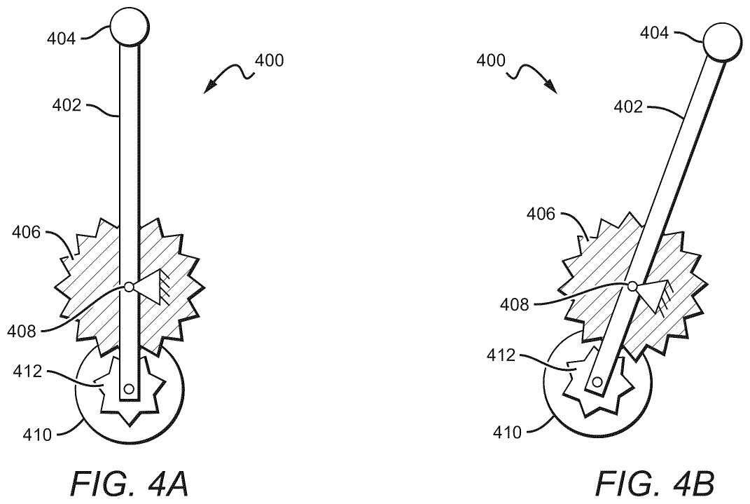

FIGS. 4A-4B illustrate a schematic of another embodiment of a control lever 400. The control lever 400 has an upper portion 402 with a lever grip 404 at a first end. A gear 406 is stationary, such that rotation of the lever 400 causes rotation of the motor 410. The lever 400 and motor 410 are configured to rotate or pivot about a first axis at a pivot point 408. In this manner, the lever 400 rotates about the first axis.

Unlike the embodiment shown in FIG. 3, here, the lever 400 preferably mechanically fixes the upper portion 402 to a motor 410 such that the motor 410 and the upper portion 402 rotate together about the first axis at pivot point 408. The motor pinion 412 interacts with the stationary gear 406 to drive the rotation of the lever upper portion 402 which is fixed to the body of the motor 410. By attaching the motor 410 to the lever 400, a mass of the motor 410 and related components acts as a counterweight to the mass of the upper portion 402.

As discussed above, by balancing the masses below and above the pivot point 408, the center of gravity of the lever 400 is at or approximately at the pivot point 408 (i.e., at the center of rotation of the lever 400). Under such circumstances, the inertial disturbance torque cancels when the combined center of gravity is at the pivot point 408. This advantageously allows the control lever 400 to be immune to force disturbances due to external accelerations without the need for a separate counterweight. While this embodiment decreases the overall mass of the system due to the lack of a separate weight acting as a counterbalance, the use of the motor 410 as a counterweight still requires significant volume to accommodate the sweeping motor 410 (compare FIG. 4A with FIG. 4B). In addition, sweeping of the motor 410 likely results in moving wires which are subject to fatigue failure.

The relationship of the torque of the components of the lever 400 is shown in the following formula:

$${T}_{l e v e r} = ( {T}_{grip} + {T}_{motor} ) + {T}_{input}$$

Thus, when the torque due to the mass of the lever upper portion 402 (simplified in the formula as T_{grip}) and torque due to the mass of the motor 410 (Tₘₒₜₒᵣ) are equal but opposite values, the values cancel one another, and the torque of the lever 400 equals the input torque (input force Tᵢₙₚᵤₜ). In this manner, force sensors can accurately determine the input force applied to the upper portion 402 of the lever 400.

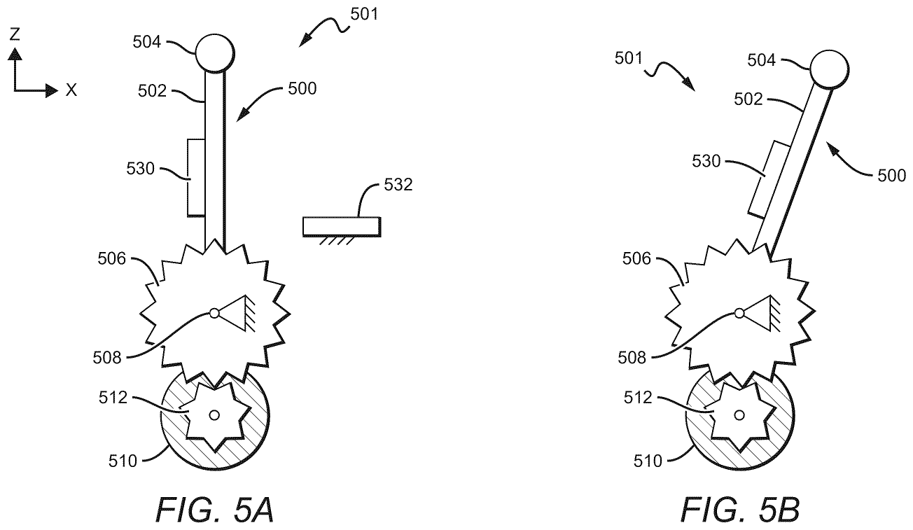

FIGS. 5A-5B illustrate a schematic of an embodiment of an inceptor system 501 for an aircraft comprising a control lever 500. In this embodiment, the system 501 provides an active lever configuration with electronic force sensor filtering. The control lever 500 has an upper portion 502 with a lever grip 504 at a first end. A gear 506 is fixed to the control lever 500, such that rotation of the lever 500 causes rotation of the gear 506. The lever 500 and gear 506 are configured to rotate or pivot about a first axis at a pivot point 508 having a first axis. In this manner, the lever 500 rotates about the first axis.

The lever 500 is preferably mechanically coupled to a stationary motor 510 via the gear 506 that interacts with a motor pinion 512. Unlike the embodiment shown in FIG. 4, motor 510 is stationary and does not move during rotation of the lever 500 about the pivot point 508 (compare FIG. 5A with FIG. 5B).

The system 510 utilizes an active filter control comprising a force sensor 530 disposed on the upper portion 502 of the lever 500 and a separate acceleration sensor 532 disposed externally to the lever 500 and fixed to the system 501. Sensor 530 is configured to detect an acceleration of the lever 500 (control stick). In this manner, system 501 can electronically distinguish (i.e., filter) forces due to external accelerations from forces that are monitored by acceleration sensor 532 from an input force on the lever 500 by a pilot input using one or more accelerometers 530 placed on the lever 500.

The use of an active filter control increases the overall complexity of the system 501 and may be subject to potential error rather than a naturally filtered system. Nevertheless, there may be circumstances where it is desired to combine this solution with a counterbalance if multiple forms of force sensing are desired, for example.

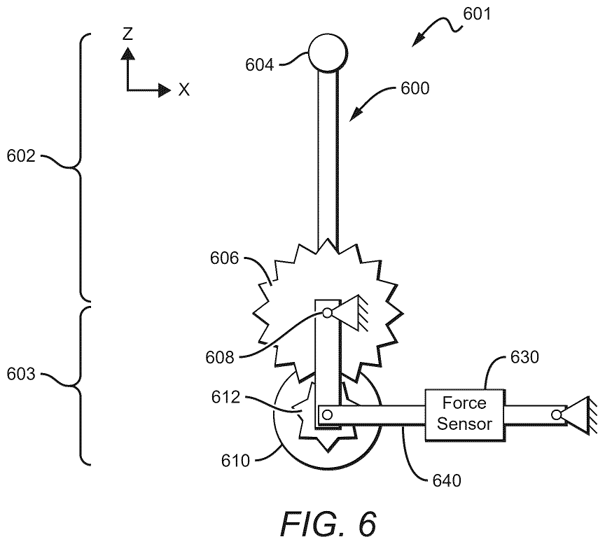

FIG. 6 illustrates a schematic of another embodiment of an inceptor system 601 for an aircraft comprising a control lever 600. The control lever 600 (control stick) has an upper portion 602 with a lever grip 604 at a first end. A gear 606 is fixed to the control lever 600, such that rotation of the lever 600 causes rotation of the gear 606. The lever 600 and gear 606 are configured to rotate or pivot about a first axis at a pivot point 608 having a first axis. In this manner, the lever 600 rotates about the first axis.

System 601 preferably comprises a lower portion 603 comprising a motor 610 that is mechanically linked to the control lever 600 such that rotation of the control lever 600 about the first axis (i.e., pivot point 608) is transmitted to the motor 610. The lower portion 603 preferably further comprises a linkage 640 that connects the motor to the lever 600.

As shown, the motor 610 may be mechanically linked to the lever 600 via gear 606 that interacts with a motor pinion 612. Unlike the embodiment shown in FIG. 3, here, motor 610 is not physically coupled to the lever 600. The motor 610 therefore may pivot about pivot point 608 (first axis) as the control lever 600 rotates about the pivot point 608 via the interaction of gear 606 and the motor pinion 612 but is constrained in place by linkage 640. Thus, the counterbalancing motor and structure (below pivot point 608) is allowed to pivot about the pivot point 608 and is constrained in place by the linkage 640 having the force sensor 630.

Preferably, a force sensor 630 (e.g., strain gauge) is coupled to the linkage 640 and configured to measure a reaction force resulting from an input force to the lever 600. The linkage 640 allows forces from the upper portion 602 to be fed to the sensor 630. Because the linkage 640 constrains movement of the motor 610, the mass of the upper portion 602 (above the pivot point 608) is balanced by the motor 610 and linkage 640 from the point of view of the force sensor 630.

In this embodiment, because the motor 610 is non-backdriveable by active or passive means with accelerations experienced in normal operation, the mass of the motor 610 and structure holding the motor 610 can behave as a counterbalance to the upper portion 602. In this manner, a mass of the lower portion 603 acts as a counterweight (i.e., is approximately equal to) to the mass of the upper portion 602. The center of gravity of the system 601 is therefore at the first axis (i.e., pivot point 608).

This is critical as it ensures sensors can distinguish induced forces on the lever from external accelerations, for example. Otherwise, where the center of gravity of the lever is far from the axis of rotation (e.g., toward the grip), the induced forces in the lever from external accelerations are indistinguishable from pilot inputs by the force sensor and can result in an active lever controller erroneously moving the lever because it assumed that sensed external accelerations were actually intended pilot inputs.

This allows for nominal mechanical counterbalancing of the lever 600 achieved by using the mass of the motor 610 without an increased volume required for sweeping due to the constraint on movement of the motor 610 by the linkage 640. System 601 can mechanically filter acceleration disturbances which would be observed by the sensor 630 with mass from the reaction load path including motor 610 rather than utilize a separate counterweight such as described with respect to FIG. 3.

As discussed above, by balancing the masses below and above the pivot point 608, the center of gravity of the system 601 is at or approximately at the pivot point 608 (i.e., at the center of rotation of the lever 600 and pivot point of linkage 640). The inertial disturbance torque cancels when the combined center of gravity is at the pivot point 408, which allows the lever 600 to be immune to force disturbances due to external accelerations without the need for a separate counterweight and allows for accurate readings by force sensor 630.

The relationship of the torque of the components of the lever 600 is represented by the following formula:

$${T}_{l e v e r} = ( {T}_{grip} + {T}_{motor} ) + {T}_{input}$$

Thus, when the torque due to the mass of the lever upper portion 602 and torque due to the mass of the motor 610 are equal but opposite values, the values cancel one another, and the torque of the lever 600 equals the input torque (input force Tᵢₙₚᵤₜ). In this manner, force sensor 630 can accurately determine the input force applied to the upper portion 602 of the lever 600 because inertial disturbance is largely counterbalanced from a point of view of the sensor 630 due to the mass of the motor/structure.

System 601 advantageously places the sensor 630 away from a crowded region at the pivot point 608 and ensures the sensor 630 does not measure unwanted forces (e.g., side loading, bending moments) since those forces are constrained at the main pivot bearing of linkage 640.

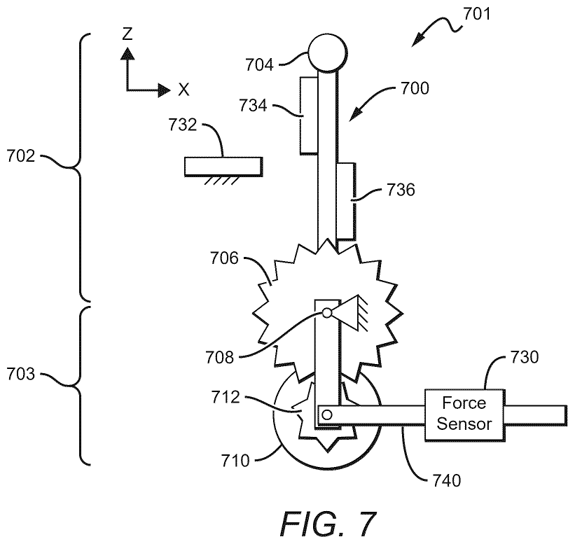

FIG. 7 illustrates a schematic of another embodiment of an inceptor system 701 for an aircraft comprising an aircraft control lever 700. System 701 is similar to that described with respect to FIG. 6 but also includes an electronic filter for the force sensor 730.

Control lever 700 (control stick) has an upper portion 702 with a lever grip 704 at a first end. A gear 706 is fixed to the control lever 700, such that rotation of the lever 700 causes rotation of the gear 706. The lever 700 and gear 706 are configured to rotate or pivot about a first axis at a pivot point 708 having a first axis. In this manner, the lever 700 rotates about the first axis.

System 701 preferably comprises a lower portion 703 comprising a motor 710 that is mechanically linked to the control lever 700 such that rotation of the control lever 700 about the first axis (i.e., pivot point 708) is transmitted to the motor 710. The lower portion 703 preferably further comprises a linkage 740 that connects the motor to the lever 700, such as described above.

As shown, motor 710 is mechanically linked to the lever 700 via gear 706 that interacts with a motor pinion 712. The motor 710 may pivot about pivot point 708 (first axis) as the control lever 700 rotates about the pivot point 708 but movement of the motor 710 is constrained by linkage 740 having force sensor 730. In this embodiment, because the motor 710 is non-backdriveable by active or passive means with accelerations experienced in normal operation, the mass of the motor 710 and structure holding the motor 710 (mass below pivot point 708) can act as a counterbalance to a mass of the upper portion 702 (above pivot point 708). The center of gravity of the system 701 is therefore at the first axis (i.e., pivot point 708).

This allows for nominal mechanical counterbalancing of the lever 700 achieved by using the mass of the motor 710 without an increased volume required for sweeping due to the constraint on movement of the motor 710 by the linkage 740. System 701 can mechanically filter acceleration disturbances which would be observed by the sensor 730 with mass from the reaction load path including motor 710 rather than utilize a separate counterweight such as described with respect to FIG. 3.

Preferably, the force sensor 730 (e.g., accelerometer) is configured to measure a reaction torque resulting from an input force to the lever 700.

System 701 advantageously places the sensor 730 away from a crowded region at the pivot point 708 and ensures the sensor 730 does not measure unwanted forces (e.g., side loading, bending moments) since those forces are constrained at the main pivot bearing of linkage 740.

Because the system 701 does not perfectly counterbalance a mass of the lever 700 over full stroke, it may be advantageous to utilize further filtering of unwanted forces. System 701 can achieve such filtering using electronic filtering such as used in the embodiment shown in FIGS. 5A-5B.

System 701 may utilize an active filter control comprising a force sensor 734 (e.g., accelerometer) disposed on the upper portion 702 of the lever 700 to detect an acceleration of the lever 700 (control stick). System 701 further comprises a separate force sensor 732 (e.g., accelerometer) disposed externally to the lever 700. Collectively, sensors 732, 734 measure gravity and accelerations of the aircraft.

In this manner, system 701 can electronically distinguish (i.e., filter) forces due to external accelerations from forces that are monitored by acceleration sensors 732 from an input force on the lever 700 by a pilot input using one or more accelerometers 734 or other force sensor(s) 736 placed on the lever 700. These forces can then be distinguished from the readings of force sensor 730 to understand the input force on the lever 700.

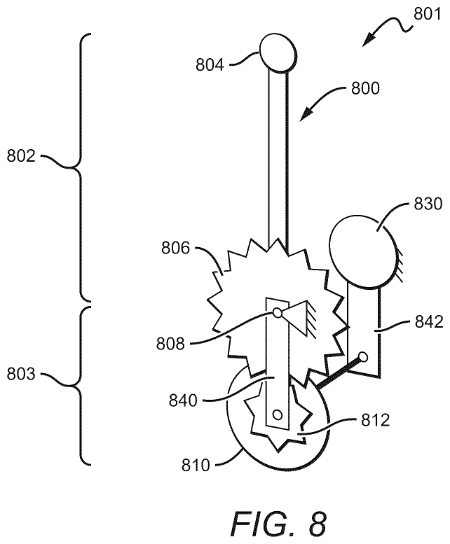

FIG. 8 illustrates a schematic of another embodiment of an inceptor system 801 for an aircraft comprising an aircraft control lever 800. Control lever 800 (control stick) has an upper portion 802 with a lever grip 804 at a first end. A gear 806 is fixed to the control lever 800, such that rotation of the lever 800 causes rotation of the gear 806. The lever 800 and gear 806 are configured to rotate or pivot about a first axis at a pivot point 808 having a first axis. In this manner, the lever 800 rotates about the first axis.

System 801 preferably comprises a lower portion 803 comprising a motor 810 that is mechanically linked to the control lever 800 such that rotation of the control lever 800 about the first axis (i.e., pivot point 808) is transmitted to the motor 810. The lower portion 803 preferably further comprises a linkage 840 that connects the motor to the lever 800 and can rotate about pivot point 808.

As shown, motor 810 is mechanically linked to the lever 800 via gear 806 that interacts with a motor pinion 812. The motor 810 may pivot about pivot point 808 (first axis) as the control lever 800 rotates about the pivot point 808 but movement of the motor 810 is constrained by a second linkage 842 coupled to a torque sensor 830.

The torque sensor 830 measures a reaction torque from the lever input force (i.e., lever grip 804). Inertial disturbances are largely counterbalanced from the point of view of the sensor 830 due to the mass of the motor 810 and related structure (mass below pivot point 808) acting as a counterbalance to the mass of the upper portion 802 (above pivot point 808). Under such circumstances, the center of gravity of the lever 801 is at the first axis (i.e., pivot point 808).

Combining the reaction load force sensing discussed herein with the lever force sensing and acceleration sensing can thereby provide error correction as well as redundancy and increased availability for the observed force by incorporating lever forces from different sources.

In the embodiments discussed above, it is contemplated that one or more of the linear force sensors could be replaced with equivalent torque sensors.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. An inceptor system for an aircraft, comprising:
a lever having a grip at a first end and configured to rotate about a pivot point at a second end;
a motor coupled to the lever such that the motor acts as a counterbalance to the lever;
wherein the lever and motor are mechanically linked by a linkage such that rotation of the lever is transmitted to the motor, wherein the linkage constrains movement of the motor, and wherein the linkage comprises a gear that mechanically couples to a pinion of the motor; and
wherein a center of gravity of the system is approximately at the pivot point.

2. The inceptor system of claim 1, wherein the motor is stationary as the lever rotates about the pivot point.

3. The inceptor system of claim 1, wherein the motor may pivot about an axis of the lever as the lever rotates about the pivot point.

4. (canceled)

5. The inceptor system of claim 1, wherein a first end of the linkage couples to the lever at the pivot point.

6. The inceptor system of claim 1, further comprising:
a force sensor coupled to the linkage and configured to measure a reaction torque resulting from an input force to the lever.

7. (canceled)

8. The inceptor system of claim 1, wherein the motor is non-backdriveable.

9. The inceptor system of claim 1, wherein the lever comprises a sensor configured to detect an acceleration of the lever.

10. A control lever of an aircraft, comprising:
an upper portion having a first mass and comprising a control stick that is configured to rotate about a first axis;
a lower portion having a second mass and comprising a motor mechanically linked to the control lever via a linkage such that rotation of the lever about the first axis is transmitted to the motor, wherein the linkage constrains movement of the motor and wherein the linkage comprises a gear that mechanically couples to a pinion of the motor; and
wherein a torque at the first axis due to the first mass of the upper portion is approximately equal and opposite to the torque at the first axis due to the second mass of the lower portion.

11. The control lever of claim 10, wherein the motor acts as a counterbalance to the control lever, such that a center of gravity of the system is at the first axis.

12. The control lever of claim 10, further comprising:
a force sensor coupled to the linkage and configured to measure a reaction torque resulting from an input force to the lever.

13. The control lever of claim 10, wherein the motor may pivot about the first axis as the control stick rotates about the first axis.

14. (canceled)

15. The control lever of claim 10, wherein the motor is non-backdriveable.

16. The control lever of claim 10, wherein the control stick comprises a sensor configured to detect an acceleration of the control stick.

17. The control lever of claim 10, wherein the motor is stationary as the control stick rotates about the first axis.
